(19) United States
(12) Patent Application Publication
(10) Pub. No.: US 2024/0381167 A1
(43) Pub. Date: Nov. 14, 2024

(54) TECHNOLOGIES FOR BUFFER DELAY INFORMATION REPORTING

(71) Applicant: APPLE INC., Cupertino, CA (US)

(72) Inventors: Ping-Heng Kuo, London (GB); Weidong Yang, San Diego, CA (US); Zhibin Wu, Los Altos, CA (US); Fangli Xu, Beijing (CN); Ralf Rossbach, Munich (DE); Peng Cheng, Beijing (CN); Yuqin Chen, Beijing (CN); Naveen Kumar R. Palle Venkata, San Diego, CA (US); Sethuraman Gurumoorthy, San Ramon, CA (US); Haijing Hu, Los Gatos, CA (US); Alexander Sirotkin, Tel Aviv (IL)

(73) Assignee: APPLE INC., Cupertino, CA (US)

(21) Appl. No.: 18/633,427

(22) Filed: Apr. 11, 2024

Related U.S. Application Data
(60) Provisional application No. 63/465,744, filed on May 11, 2023.

(51) Int. Cl. H04W 28/02

(52) U.S. Cl. CPC H04W 28/0278

(57) ABSTRACT

The present application relates to devices and components, including apparatus, systems. and methods for buffer status reporting in wireless networks.

### CROSS-REFERENCES TO OTHER APPLICATIONS

This application claims priority to U.S. Provisional Application No. 63/465,744, for “TECHNOLOGIES FOR BUFFER DELAY INFORMATION REPORTING,” filed on May 11, 2023, which is herein incorporated by reference in its entirety for all purposes.

### TECHNICAL FIELD

This application generally relates to cellular communication networks and, in particular, to technologies for uplink transmission without retransmission.

### BACKGROUND

This application relates generally to communication networks and, in particular, to technologies for buffer status reporting in such networks.

### BRIEF DESCRIPTION OF THE DRAWINGS

FIG. 1 illustrates a network environment in accordance with some embodiments.

FIG. 2 illustrates a distribution diagram in accordance with some embodiments.

FIG. 3 illustrates a block diagram in accordance with some embodiments.

FIG. 4 illustrates a data structure in accordance with some embodiments.

FIG. 5 illustrates a data structure in accordance with some embodiments. FIG. 6 illustrates a data structure in accordance with some embodiments.

FIG. 7 illustrates a data structure in accordance with some embodiments.

FIG. 8 illustrates a data structure in accordance with some embodiments.

FIG. 9 illustrates an operational flow/algorithmic structure in accordance with some embodiments.

FIG. 10 illustrates an operational flow/algorithmic structure in accordance with some embodiments.

FIG. 12 illustrates a user equipment in accordance with some embodiments.

FIG. 13 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques, in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

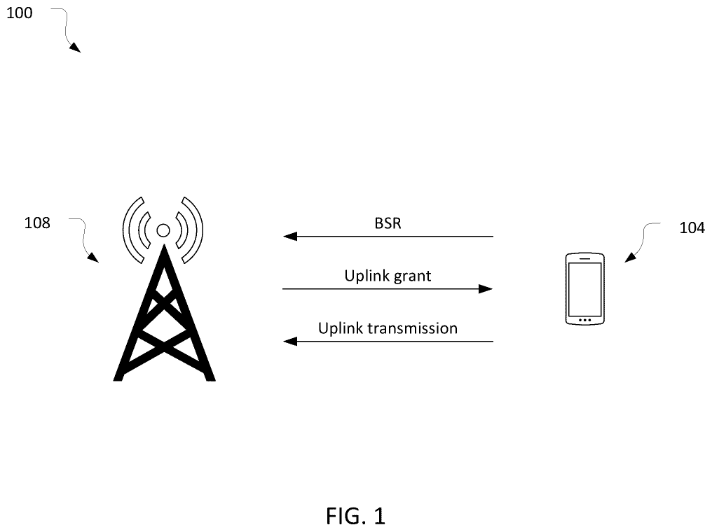

FIG. 1 illustrates a network environment 100 in accordance with some embodiments. The network environment 100 may include a UE 104 coupled with a base station (BS) 108 of a radio access network (RAN). In some embodiments, the BS 108 is a next-generation node B (gNB) that provides one or more 3GPP New Radio (NR) cells. In other embodiments, the BS 108 is an evolved node B (eNB) that provides one or more Long Term Evolution (LTE) cells. The air interface over which the UE 104 and the BS 108 communicate may be compatible with 3GPP technical specifications (TSs), such as those that define Fifth Generation (5G) NR or later system standards (e.g., Sixth Generation (6G) standards).

The UE 104 may send a buffer status report (BSR) to the base station 108 to indicate an amount of uplink data that UE 104 has to transmit. The BSR may be transmitted as a media access control (MAC) control element (CE) on a physical uplink shared channel (PUSCH). The BSR may be associated with a logical channel (LCH) or a logical channel group (LCG) having one or more LCHs. Upon receiving the BSR, the BS 108 may determine an appropriate amount of uplink (UL) resources for the UE 104. The BS 108 may then transmit an uplink grant to the UE 104. The UE 104 may use the UL grant for a subsequent UL transmission.

In various embodiments, the UE 104 may transmit a regular BSR, a periodic BSR, or a padding BSR. A regular BSR may be triggered in the event new uplink data of an LCH of an LCG becomes available in a MAC buffer, and either the LCH has a higher priority than any other LCH having buffered data or no other LCH has buffered data. A regular BSR may also be triggered in the event a retransmit BSR timer (retxBSR-Timer) expires and an LCH includes buffered data to be transmitted. The retransmit BSR timer may be used to avoid a deadlock situation that may occur if the base station 108 fails to receive a BSR, but the UE 104 believes the BSR transmission was successful. Thus, the retransmit BSR timer provides a limited period of time for the UE 104 to wait for the uplink grant before retransmitting the BSR. The retransmit BSR timer is started when a BSR is multiplexed into a MAC protocol data unit (PDU).

Existing networks include a number of BSR formats, including a short BSR format (fixed size), an extended short BSR format (fixed size), a long BSR format (variable size), an extended long BSR format (variable size), a short truncated BSR format (fixed size), a long truncated BSR format (variable size), and an extended long truncated BSR format (variable size). Selection between these formats in existing networks is fixed in clause 5.4.5 of 3GPP TS 38.321 v.17.4.0 2023 Mar. 29. The selection may be based on the number of LCGs that have data available for transmission, whether the MAC entity has a logical channel group IAB extension (logicalChannelGroup-IAB-Ext) configured, and, for padding BSR, the number of available padding bits compared to the size of various of the formats.

Traffic types are evolving to accommodate new use cases in developing cellular networks. For example, efforts are being undertaken to improve RAN operation to support traffic having characteristics associated with extended reality (XR) traffic to provide, for example, high throughput, low latency, and high reliability. Various enhancements to BSR operation may be used to improve capacity for XR use cases. While some embodiments are described with reference to XR traffic, other embodiments may apply similar concepts to other types of traffic.

BSR tables having a finer granularity than existing tables may be used to enhance BSR for XR use cases. Existing BSR tables in 3GPP TS 38.321 have a quantization error of the buffer size levels that increases for higher buffer size levels. As packet sizes for XR traffic may be quite large (for example, with reference to a video frame), the quantization error may lead to a degradation of resource efficiency.

XR traffic may operate based on a PDU set. The PDU set, which may correspond to an application data unit, may include a plurality of packets/PDUs. A user plane function (UPF) may identify a PDU set based on a PDU set sequence number (SN); a start/end PDU of the PDU set, a PDU SN within a PDU set, or a number of PDUs within a PDU set.

A quality of service (QOS) flow may be identified using a QoS flow ID, and each PDU set within the QoS flow may be identified using the PDU set SN. Each QoS flow can be used to deliver one or more PDU sets.

The UPF may further identify information relating to the PDU set, such as the importance of a PDU set or a dependency on it. The UPF may provide the information relating to PDU sets to a RAN.

QOS parameters for PDU-set based QoS handling may include a PDU set delay budget (PSDB), a PDU set error rate (PSER), whether to drop a PDU set in case a PSDB is exceeded, whether all PDUs are needed for the usage of a PDU set by an application layer and a PDU set priority.

The characteristics of a buffered PDU set (for example, an importance level of the PDU set) may be indicated in a BSR.

Different data units may be buffered in the buffer of an LCH or an LCG. For example, the data units may belong to different PDU sets with different delivery deadlines. The data units may arrive at the buffer at different times, e.g., due to jitter. Moreover, data units may be associated with different QoS flows. Data units may be buffered in different LCHs or LCGs with different delay information.

Generally, a data unit may be any portion of the buffered data. In some instances, a data unit may refer to: one packet data convergence protocol (PDCP) service data unit (SDU) or one PDCP PDU, one group of multiple PDCP SDUS or PDCP PDUs, one radio link control (RLC) PDU or RLC SDU, an RLC SDU segment, one group of multiple RLC PDUs, one group of multiple RLS SDUs, one group of RLS SDU segments, one PDU set, one group of PDU sets, or a portion of buffered data associated to a particular QoS flow.

The BSR may be enhanced for XR use cases by including additional types of information. Existing BSRs only provide information about buffer size. To facilitate delay-aware scheduling for XR traffic with latency constraints, the BSR may further include information relating to the delay status of the buffered data. For example, the BSR may include an indication of how long the data has been queued, the amount of time that remains until a delivery deadline, or the estimated time until the end of the transmission of a packet.

There are several ways that UE can report buffer delay information. In some instances, the UE may report one buffer delay information for each LCH or LCG. For example, the UE may report the shortest remaining time until the delivery deadline among all data units in an LCH or an LCG. Reporting a single delay information may cause a small amount of overhead. However, the delay information may mislead the scheduler. For example, the buffer may include urgent and non-urgent. The urgent data may have a smaller remaining time until delivery deadline than the non-urgent data. By reporting the remaining time until delivery of the urgent data, the network may associate all the buffered data with delay information of the urgent data, causing the network to allocate resources inappropriately.

In some embodiments, the UE 104 may compress, quantize, or encode the delay information. The UE 104 may map the delay information into codewords. In some instances, the UE 104 may use a table to compress, quantize, or encode the delay information. Each entry of the table may be associated with a codeword or an index where the codeword may have a smaller number of bits than a binary representation of the delay information without quantization or compression. The UE 104 may map the delay information to an entry, denoted by ENTRY, in the table. The table may associate ENTRY with an index or codeword, and the UE 104 may report this index or codeword to represent the delay information. In some embodiments, an index or codeword may be reserved to indicate that the delay information does not correspond to a valid value or that the delay information reporting is not applicable, e.g., the UE is not configured to measure/report delay information of a corresponding LCH/LCG.

In some instances, the UE may report more than one buffer delay information. For example, the UE may report the delay information for some or all data units buffered in an LCH or LCG. The network may have complete information about the UL buffer of the UE and can implement more advanced scheduling algorithms at the cost of a larger feedback overhead. In particular, the report may associate each delay information with its corresponding data unit, resulting in a larger overhead and a complex MAC CE design. Improving the performance of delay-aware scheduling with a smaller increase in the overhead is desired.

In some embodiments, the UE may report attributes associated with the distribution of buffer delay values. For example, the UE may report delay values associated with a selected percentile. In some instances, the UE may report statistical parameters associated with the delay values of the buffered data units.

In some embodiments, when reporting multiple delay information, the UE may differentially encode the delay information. For example, the report may include a reference and a dependent (or differential) report. The reference report may contain first delay information. The UE may compute differential delay information based on a second delay information and the first (reference) delay information, e.g., by subtracting the second delay information from the first delay information. The dependent report may contain differential delay information. The UE may use reference tables to quantize the buffer delay values, and the delay information indicates entries in the reference tables. Some embodiments may disclose MAC CE structures to report one or more delay information.

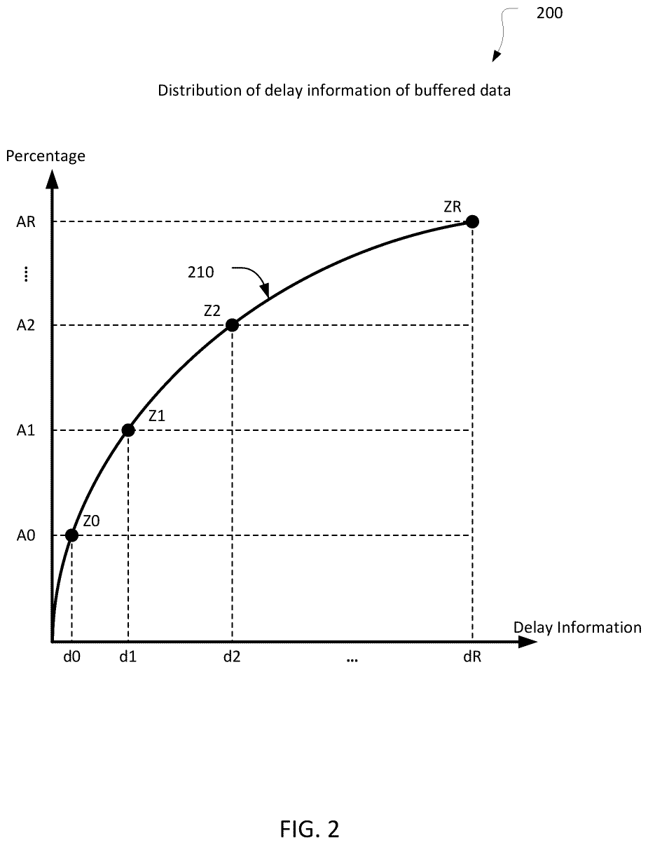

FIG. 2 illustrates a distribution diagram 200 in accordance with some embodiments. Distribution diagram 200 is an example of a distribution of delay information of buffered data.

The UE may report delay information. The delay information is obtained from a measurement. For example, the UE measures the time data units have been waiting in the buffer. A data unit may have a deadline by which it has to be delivered. In another example, the UE measures the remaining time until the delivery deadline. Therefore, each data unit in a buffer may be associated with a delay value.

The UE may use delay values of data units distributed across different portions of the buffered data in one or more LCH or LCG to compute a cumulative distribution function (CDF) 210. The vertical axis of the distribution diagram 200 is the percentile, and the horizontal axis is the delay information. Every point on the CDF curve 210 corresponds to a delay information value, d, and a percentile value, A. For example, point Z0 on the CDF curve 210 corresponds to delay information d0 and percentile value A0, indicating that A0 percent of the data units in the buffer have delay information of d0 or less.

For example, consider that A0 is 25%, and do is 10 milliseconds (ms)-measuring the remaining time until delivery deadline-where do and A0 correspond to point Z0 on the CDF curve 210. Point Z0 may indicate that 25% of buffered data have a remaining time until delivery deadline smaller or equal to 10 (ms).

In one embodiment, the network determines R+1 percentile values, A0, A1, A2, . . . , AR, and configures the UE with the percentile values. For example, the BS may send the percentile values to the UE by common or dedicated radio resource control (RRC) signaling, or the percentile values may be specified in 3GPP TSs. The UE computes the delay CDF 210 of a subset of its buffered data units. Having the percentile values and the CDF curve 210, the UE may compute the delay information values, d0, d1, d2, . . . , and dR.

The UE may report the set of buffer delay values {d0, d1, d2, . . . , dR} or a subset of it. The UE may report the buffer delay values and the buffer size information. The UE may report the buffer delay values in the same report with buffer size information or in a report that does not include buffer size information. For example, the UE may use a first MAC CE to report the buffer delay values and a second MAC CE to report the buffer size information. The UE may send the first and second MAC CEs on the same UL transmission or be scheduled in separate UL transmissions.

In one embodiment, the UE may compute statistical parameters of the buffer delay values and report a set of multiple statistical parameters. The statistical parameters may be associated with one or more LCHs or LCGs. Examples of statistical parameters that UE may compute and report may include, and are not limited to, the maximum value of delay information in the buffer, the minimum value of delay information in the buffer, the average value (mean) of delay information in the buffer, the median (middle value of sorted delay information) of delay information in the buffer, the standard deviation of delay information in the buffer, or the variance of delay information in the buffer.

The BS may configure the UE to report the set of buffer delay values, d0-dR, of the CDF 210 or the statistical parameters. The BS may configure the UE dynamically via downlink control information (DCI) or semi-statically via RRC signaling.

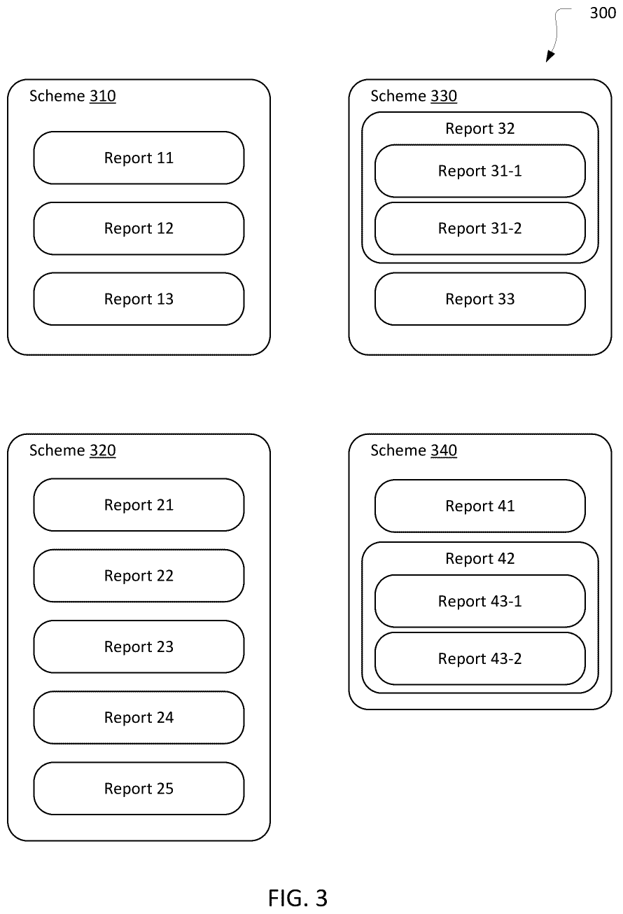

FIG. 3 illustrates a block diagram 300 in accordance with some embodiments. Block diagram 300 is an example of delay information reporting models in one control message. Block diagram 300 includes schemes 310, 320, 330, and 340, providing models for reporting multiple delay information in one MAC CE.

There are several instances in which the UE may report multiple buffer delay information. What follows includes examples of scenarios in which the UE reports multiple buffer delay information. These examples are intended to explain by way of example and are not intended to be limiting. For example, the UE may report multiple delay information corresponding to the buffer of different LCHs or LCGs in one MAC CE. The UE may report multiple delay information corresponding to different data units, e.g., PDU sets, in the buffer. The UE may report multiple delay information corresponding different percentiles of the buffered data. The UE may report multiple delay information corresponding to different statistical attributes of the buffered data. Some examples above may be combined, e.g., the UE may report delay information for multiple data units buffered in multiple LCHs or LCGs.

In one embodiment, the control message for reporting buffer delay information may include a reference report and a dependent report. The UE may designate a first buffer delay information as the reference report. The reference report may include the first buffer delay information or an indication of it. The UE computes the dependent (or differential) report based on the second buffer delay value(s) and the reference report, e.g., the first buffer delay information. For example, the differential report may be the difference (subtraction) of the first and second buffer delay information.

In one embodiment, the UE may construct MAC CE by quantizing the reference delay information and differential delay information. The reference report portion of the MAC CE may contain the quantized value or an indication of the reference delay information. Similarly, the dependent report portion of the MAC CE may contain the quantized value or an indication of the differential delay information.

Scheme 310 is an example of reporting one reference report with multiple differential reports in one MAC CE. The UE may designate a first delay information and assign it to the reference report R11. The UE may compute and generate a first dependent report, R12, with respect to the reference report. For example, the UE may compute R12 by subtracting a second delay information from the first delay information. The UE may compute and generate a second dependent report, R13, with respect to the reference report. For example, the UE may compute R13 by subtracting a second delay information from the first delay information. The UE may generate the control report, e.g., the MAC CE, based on the reference report, R11, the first dependent report R12, and the second dependent report R13.

Scheme 320 is an example of reporting two reference reports with multiple differential reports in one MAC CE. The UE may designate a first delay information and assign it to the first reference report, R21. The UE may compute and generate a first dependent report, R22, with respect to the first reference report. For example, the UE may compute R22 by subtracting a second delay information from the first delay information.

The UE may designate a third delay information and assign it to the second reference report, R23. The UE may compute and generate a second dependent report, R24, with respect to the second reference report. For example, the UE may compute R24 by subtracting a fourth delay information from the third delay information. The UE may compute and generate a third dependent report, R25, with respect to the second reference report. For example, the UE may compute R25 by subtracting a fifth delay information from the third delay information.

The UE may generate the control report, e.g., the MAC CE, based on the reference report R21, the first dependent report, R22, the second reference report, R23, the third dependent report, R24, and the third dependent report, R25.

Scheme 330 is an example of merging similar reports into one reference report with one or more differential reports in one MAC CE. The UE may prepare delay reports 31-1, 31-2, and 33. The UE may determine that delay reports 31-1 and 32-2 have similar values. The UE may represent 31-1 and 31-2 reports with a single reference report 32 in the MAC CE. The UE may use the reference report to compute the differential report 33. As a result, the MAC CE may include reference report 32 and differential report 33. The UE may determine two reports are similar when their difference is smaller than a threshold.

Scheme 340 is an example of reporting in one MAC CE, one reference report, and merging multiple differential reports into one differential report. The UE may prepare delay reports 41, 43-1, and 43-2. The UE may determine that delay reports 43-1 and 43-2 have similar values. The UE may represent 43-1 and 43-2 reports with a single reference report 42 in the MAC CE. The UE may use reference report 41 to compute the differential report 43. As a result, the MAC CE may include reference report 32 and differential report 33. The UE may determine two reports are similar when their difference is smaller than a threshold.

In one embodiment, the UE may combine schemes 330 and 340. The MAC CE may include one reference report corresponding to a first group of multiple delay reports and one differential report corresponding to a second group of multiple delay reports. The MAC CE may indicate whether delay reports are merged and represented with a common value.

In one embodiment, the MAC CE may indicate the reference reports and the association between the dependent and reference reports. In another embodiment, the BS may infer the reference reports from the size of the report, e.g., the resources allocated to the report. The BS may infer the association between the reference and dependent reports based on the order of reports in the MAC CE.

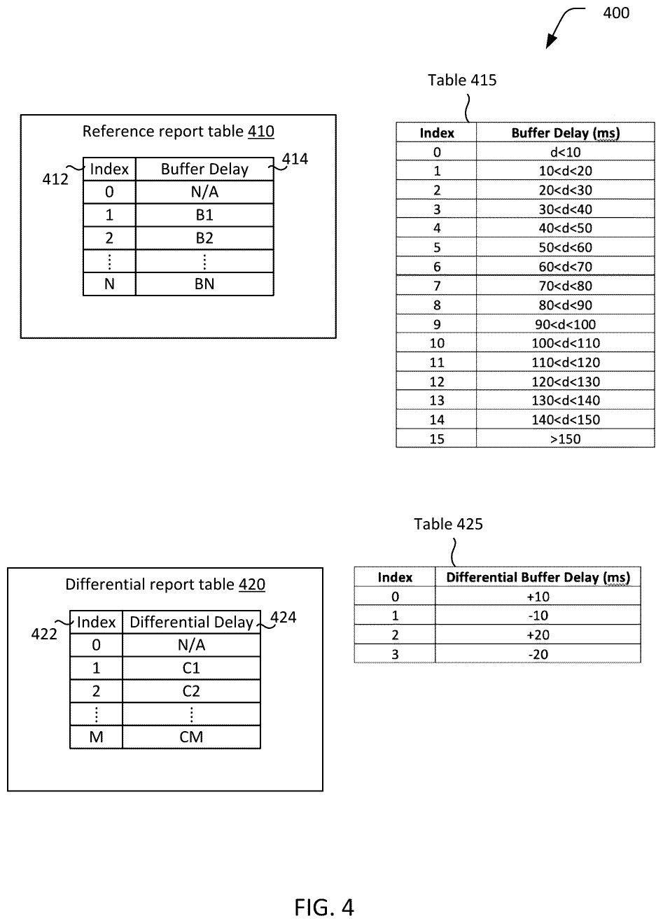

FIG. 4 illustrates a data structure 400 in accordance with some embodiments. Data Structure 400 is an example of tables used by the UE to create reference and differential reports.

Table 410 is an example of a reference report table. Table 410 may include an index 412 column and a buffer delay 414 column. Table 410 may create an association among the entries in the same row of the table. For example, index ‘1’ and buffer delay B1 are in the same row, and as such, the buffer delay B1 is associated with index ‘1’. The entries in the buffer delay column, B1, B2, . . . , BN, could be delay values or delay intervals. The UE may compare a buffer delay value with entries in the buffer delay 414 column and map the buffer delay value to an entry, denoted as ENTRY, in the buffer delay 414 column. The UE may set the delay report to be the ENTRY or the index associated with the ENTRY.

In some instances, the entries of the buffer delay 414 column represent a delay interval. For example, B1 may be an interval, e.g., B1=[a1, a2], which means a delay value larger than or equal to al but smaller than or equal to a2. An interval may implicitly or explicitly be represented with a value. For example, the interval [a1, a2] may be represented by a delay value, b1, in that interval, e.g., b1 is in [a1, a2]. An explicit representation may be implemented by a column (not in the picture) in table 410 that associates each interval with a representative value. An implicit representation may associate each interval with a value using a rule or a formula. For example, an interval may be represented by the value of one of its limit points or by the value of its middle point.

A row in table 410 may be reserved to indicate that the delay does not correspond to a valid value or that the reference reporting is not applicable, e.g., the UE is not configured to measure/report delay information of the corresponding LCH/LCG. For example, the index value ‘0’ may indicate that the reference reporting is not applicable or that the measured value is outside of the range supported by the table.

Table 415 is an example of reference report table 410 using delay intervals as entries. The example is provided to facilitate explanation and is not intended as a restriction or limitation. The table can be used as a quantization table. For example, table 415 has 16 indices that can be represented with 4 bits. Any delay value can be mapped to a row in Table 415. For example, a delay value of 57 (ms) can be mapped to the interval 50<d<60 (ms) in row 6, associated with index=5. Therefore, the delay report may use the four bits associated with the index to report the delay information. The BS, upon reception of the report, may infer that the reported delay has a value between 50 (ms) and 60 (ms).

Table 420 is an example of a differential report table. Table 420 may include an index 422 column and a buffer delay 424 column. Table 420 may create an association among the entries in the same row of the table. For example, index ‘1’ and buffer differential delay C1 are in the same row; as such, the differential delay C1 is associated with index ‘1’. The entries in the differential delay column, C1, C2, . . . , CM, could be positive or negative differential delay values. The UE may compute a differential buffer delay by subtracting the buffer delay value of data units from the reference buffer delay report. The UE may compare the differential buffer delay value with entries in the differential delay 424 column and map the differential buffer delay value to an entry, denoted as ENTRY, in the 424 column. The UE may set the differential delay report to be the ENTRY or the index associated with the ENTRY.

Table 425 is an example of the differential report table 420 using differential delay values as entries. The example is provided to facilitate explanation and is not intended as a restriction or limitation. The table can be used as a quantization table. For example, table 425 has 4 indices that can be represented with 2 bits. Any differential del close to +10 (ms) can be mapped to index=0. For example, a differential delay between 0 (ms) and 15 (ms) may be mapped to index=0. Therefore, the delay report may use the two bits associated with the index to report the delay information. The BS, upon reception of the report, may infer that the reported differential delay has a value of +10 (ms).

In some embodiment, that UE may have one reference report table 410 and one differential report table 420 for all configured LCHs or LCGs. Alternatively, the UE may have different reference tables associated with different LCHs or LCGs or different differential tables associated with different LCHs or LCGs.

When receiving a differential report, the BS may compute the delay information by adding the differential delay associated with the differential report to the reference delay associated with the reference report.

The UE may select the delay information associated with the reference report as one of the following reports.

The UE may select the reference report to be associated with the delay information associated with the data unit with the largest (or smallest) size.

The UE may select the reference report to be associated with the delay information associated with the data unit with the earliest arrival time at the buffer.

The UE may select the reference report to be associated with the delay information associated with the data unit with the latest arrival time at the buffer.

The UE may select the reference report to be associated with the delay information associated with the data unit with the minimum (or maximum) remaining time until its delivery deadline.

The UE may select the reference report to be associated with the delay information associated with the data unit closest to the average remaining time until delivery of the buffered data units.

The UE may select the reference report to be associated with the delay information associated with the data unit with the minimum (or maximum) remaining time until being discarded (based on the discard timer setting).

The UE may select the reference report to be associated with the delay information associated with the data unit closest to the average remaining time until the buffered data units are discarded.

The UE may select the reference report to be associated with the delay information associated with the data unit corresponding to a PDU set with the highest (or lowest) importance, e.g., based on PDU set importance information.

The UE may select the reference report to be associated with the delay information associated with the data unit corresponding to the lowest (or highest) QoS flow ID.

The UE may select the reference report to be associated with the delay information associated with the data unit with the maximum (or minimum) packet delay budget (PDB) or PDU set delay budget (PSDB).

The UE may select the reference report to be associated with the delay information associated with the data unit buffered in the lowest (or highest) LCH ID.

The UE may select the reference report to be associated with the delay information associated with the data unit buffered in the lowest (or highest) LCG ID.

The UE may select the reference report to be associated with the delay information associated with the data unit that shares a common delay information with most other data units in the buffer.

The UE may select the reference report to be associated with the delay information associated with the data unit with the minimum or maximum remaining time until its delivery deadline.

The UE may select the reference report to be associated with the delay information associated with the data unit with the minimum or maximum remaining time until its delivery deadline.

The UE may select the reference report associated with the delay information associated with the highest (or lowest) percentile value.

The UE may select the reference report to be associated with the delay information associated with the maximum value, the minimum value, the average value, the median value, the standard deviation value, or the variance value of delay information in the buffer.

The 3GPP TSs may fix the selection rule for the reference report. The network may configure the UE using the selection rule. For example, the BS may send RRC signaling to configure the UE with the selection rule.

In some embodiments, the UE may compress, quantize, or encode the delay information. The UE may map the delay information into codewords. In some instances, the UE may use table 410 to compress, quantize, or encode the delay information even when the UE does not utilize reference and differential delay reporting. Each entry in Table 410 may be associated with a codeword or an index, where the codeword may have a smaller number of bits than a binary representation of the delay information without quantization or compression. The UE may map the delay information to an entry, denoted by ENTRY, in the table. The table may associate ENTRY with an index or codeword, and the UE may report the associated index or codeword to represent the delay information. In some embodiments, an index or codeword may be reserved to indicate that the delay information does not correspond to a valid value or that the delay information reporting is not applicable, e.g., the UE is not configured to measure/report delay information of a corresponding LCH/LCG.

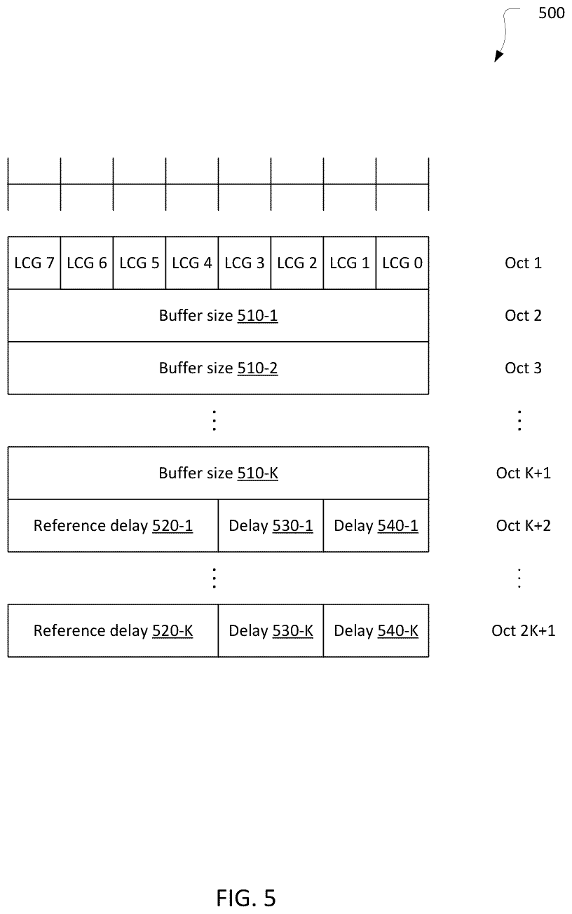

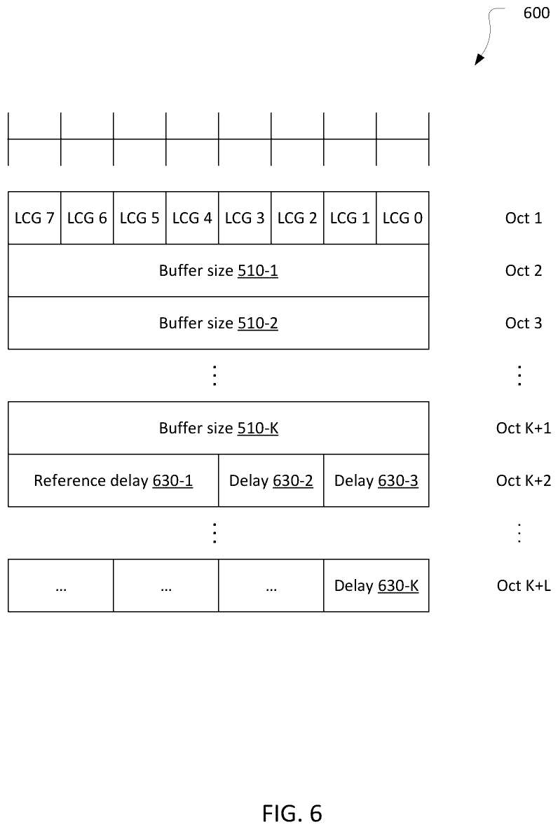

FIG. 5 illustrates a data structure 500 in accordance with some embodiments. Data structure 500 is an example of MAC CE format based on an extension of the long BSR format. The MAC CE format may include information elements associated with delay information. For example, the MAC CE may include IE for reference or dependent reports.

Data structure 500 may include bitmap LCG0-7 on the first octet, Oct 1. If set, each bit in the bitmap indicates that the MAC CE contains information associated with the corresponding LCG. For example, if LCG0 is set, e.g., has a value of ‘1’, it indicates that MAC CE contains information related to LCG associated with LCG0. The next K octets, Oct 2-K+1, include buffer size 510-1 to 510-K. The buffer size may be indicated using one or more octets and may indicate the size of a buffer of the UE 104.

For each buffer size 501, the MAC CE may include buffer delay information. The MAC CE in data structure 500 includes one octet for each buffer size. For example, octet K+1 may include buffer delay information 520-1, 530-1, and 540-1 related to buffers size 510-1. The delay information 520-1 may be a reference delay information associated with the first delay report of buffer size 510-1. The delay information 530-1 may be a differential delay information for the second delay report of the buffer size 510-1, and the delay information 540-1 may be a differential delay information for the third delay report of the buffer size 510-1. Similarly, the delay information 520-K may be a reference delay information associated with the first delay report of buffer size 510-K. The delay information 530-K may be a differential delay information for the second delay report of the buffer size 510-K, and the delay information 540-K may be a differential delay information for the third delay report of the buffer size 510-K.

In some embodiment, two or more buffer size elements may share the same delay information, e.g., according to schemes 330 or 340 in FIG. 3. Additional fields in MAC CE may be needed to indicate if any delay information elements commonly correspond to multiple buffer size elements.

FIG. 6 illustrates a data structure 600 in accordance with some embodiments. Data structure 600 is an example of MAC CE format based on an extension of the long BSR format. The MAC CE format may include information elements associated with delay information. For example, the MAC CE may include IE for reference or dependent reports. Data structure 600 includes bitmap and buffer size 510-1 to 510-K as described above in FIG. 5.

In data structure 600, each buffer size that corresponds to an LCG is also associated with one delay information. One of the LCGs may be chosen as the reference. The delay information associated with the reference LCG is reported as reference delay information 630-1. The delay information of other LCGs with a buffer size report is reported based on the differential values, e.g., differential delay information reports 630-2 to 630-K. For example, reference delay information 630-1 may correspond to buffer size 510-1. Differential delay information report 630-2 may correspond to buffer size 510-2, and differential delay information report 630-K may correspond to buffer size 510-K.

In some embodiment, two or more buffer size elements may share the same delay information, e.g., according to schemes 330 or 340 in FIG. 3. Additional fields in MAC CE may be needed to indicate if any delay information elements commonly correspond to multiple buffer size elements.

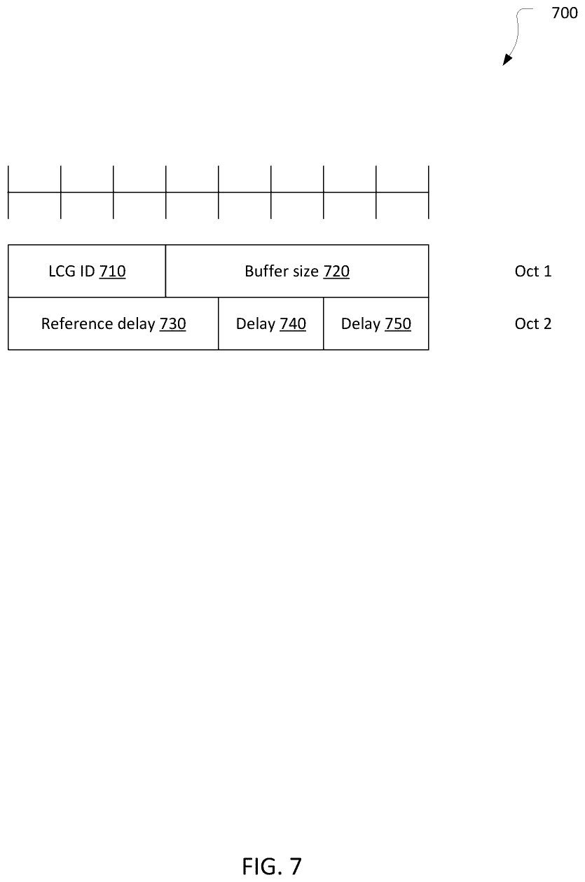

FIG. 7 illustrates a data structure 700 in accordance with some embodiments. Data structure 600 is an example of MAC CE format based on an extension of the short BSR format.

The first octet of the MAC CE may include an LCG identifier (LCG ID) 710 and buffer size 720. The LCG ID 710 may identify the LCG (or LCH) to which the MAC CE relates. The second octet includes delay information related to the identified LCG. MAC CE 700 may include a reference delay 730 and one or more differential reports. For example, the MAC CE may include two differential reports, 740 and 750.

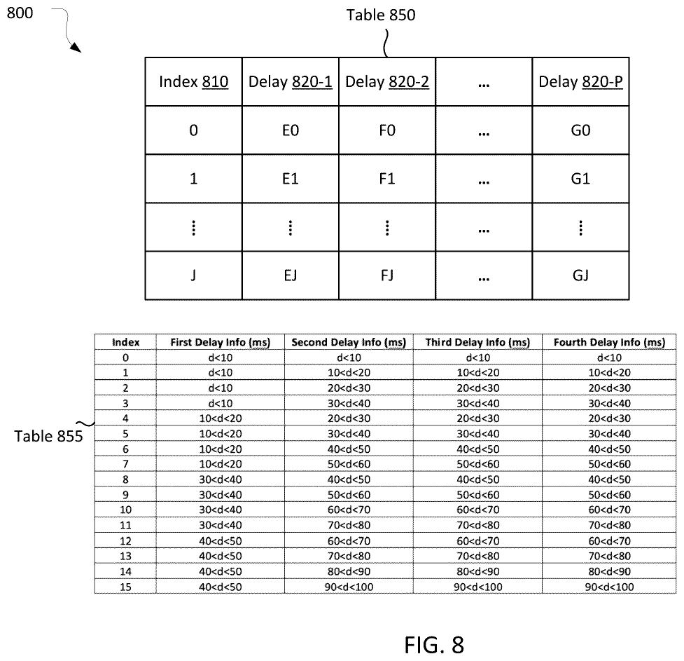

FIG. 8 illustrates a data structure 800 in accordance with some embodiments. Data structure 800 is an example of a table for multiple buffer delay information. One way to reduce feedback overhead is to associate multiple delay information values with one index.

Table 850 may include index 810 to index each row of the table. Entries in each row of table 850 are associated with the index associated with that row. For example, all the entries in the second row of Table 850 are associated with index ‘1’. Table 850 may have J+1 rows associated with indices 0-J. Table 850 may also include P columns 820-1 to 820-P associated with delay information. Column 820-1 may be associated with the first delay information with entries E0-EJ. Column 820-2 may be associated with second delay information with entries F0-FJ, and column 820-P may be associated with the ‘p’th delay information with entries G0-GJ.

In some instances, the entries of the delay columns 820-1 to 820-P represent a delay interval. For example, E1 may be an interval, e.g., E1=[b1, b2], which means a delay value larger than or equal to b1 but smaller than or equal to b2. An interval may implicitly or explicitly be represented with a value. For example, the interval [b1, b2] may be represented by a delay value, c1, in that interval, e.g., c1 is in [b1, b2]. An explicit representation may be implemented by a column (not in the picture) in table 850 that associates each interval with a representative value. An implicit representation may associate each interval with a value or a formula. For example, an interval may be represented by the value of one of its limit points or by the value of its middle point. In some instances, the delay intervals in the same row may be the same. For example, E1 and F1 may indicate the same delay interval. In some instances, the delay intervals in the same row may overlap. For example, E1 and G1 may intersect with one another. In some instances, the delay intervals in the same row may be disjoint. For example, EJ and GJ may be disjoint.

Table 855 is an example of table 850 using delay intervals as entries. The example is provided to facilitate explanation and is not intended as a restriction or limitation. The table can be used as a quantization table. For example, table 855 has 16 indices that can be represented with 4 bits. Any delay value may be mapped to a row in Table 855. For example, a first delay value of 15 (ms), a second delay value of 45 (ms), a third delay value of 47 (ms), and a fourth delay value of 41 (ms) can be mapped to the row with index=6. Therefore, the delay report may use the four bits associated with the index to report the four delay information. The BS, upon reception of the report, may infer that the reported delay corresponds to a first delay value between 10 (ms) and 20 (ms), a second delay value between 40 (ms) and 50 (ms), a third delay value between 40 (ms) and 50 (ms), and a fourth delay value between 40 (ms) and 50 (ms).

In one embodiment, a row in table 800 may be reserved to indicate that multiple delay reporting is not applicable. For example, the index value ‘0’ may indicate that the reporting using table 800 is not applicable or that one or more measured values may be outside of the range supported by the table.

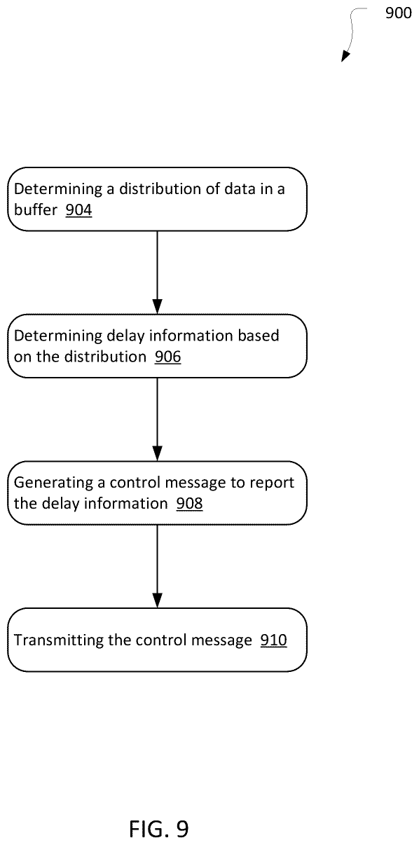

FIG. 9 illustrates an operational flow/algorithmic structure in accordance with some embodiments. The operation flow/algorithmic structure 900 may be implemented by a MAC entity in a UE (for example, UE 104 or UE 1200) or components therein, for example, processing circuitry 1204.

The operation flow/algorithmic structure 900 may include, at 904, determining a distribution of data in a buffer. For example, the UE may determine the CDF of the delay values of the data in the buffer. The distribution may be associated with the waiting time of the data in the buffer, the remaining time until a delivery deadline of the data in the buffer, or an estimated time until completing transmission of the data in the buffer. The data in the buffer may be associated with one or more LCH or one or more LCG.

The operation flow/algorithmic structure 900 may include, at 906, determining, based on the distribution, delay information corresponding to percentile values. The UE may be configured with one or more percentile values. The UE finds the delay information associated with the percentile such that each delay information and its corresponding percentile is associated with the CDF.

The operation flow/algorithmic structure 900 may include, at 908, generating a control message based on the delay value. For example, the UE may generate a MAC CE, in accordance with the embodiments herein, and include the delay information and an indication of the delay information in the MAC CE.

The operation flow/algorithmic structure 900 may include, at 910, transmitting the control message. The UE may send the MAC CE to the UE in an uplink transmission on the physical uplink control channel (PUCCH) or physical uplink shared channel (PUSCH).

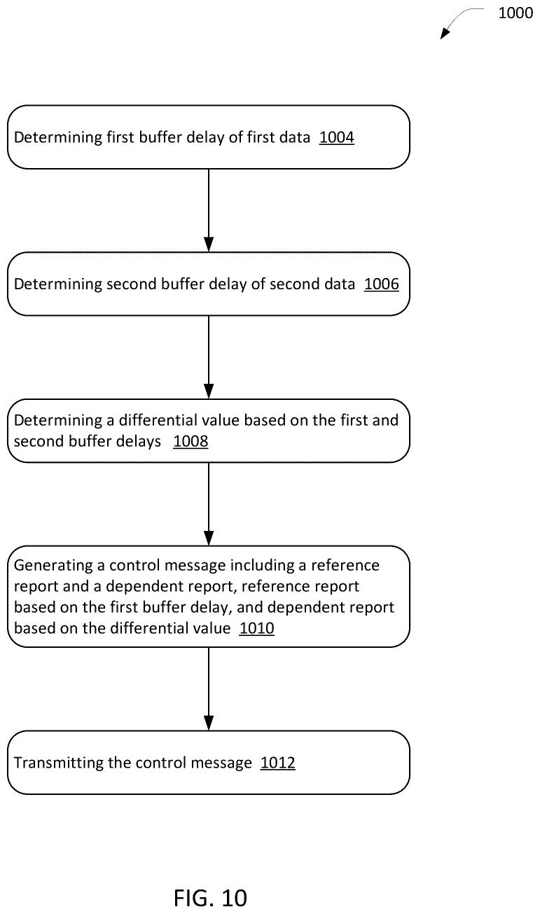

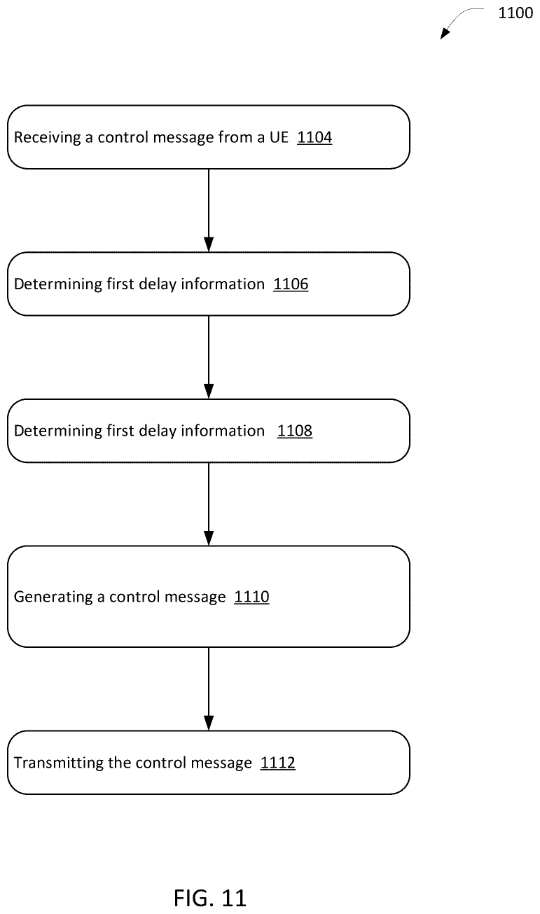

FIG. 10 illustrates an operational flow/algorithmic structure in accordance with some embodiments. The operation flow/algorithmic structure 1000 may be implemented by a MAC entity in a UE (for example, UE 104 or UE 1200) or components therein, for example, processing circuitry 1204.

The operation flow/algorithmic structure 1000 may include, at 1004, determining first delay information associated with first data in a buffer. For example, the delay information may be based on the data's CDF and statistical attributes.

The operation flow/algorithmic structure 1000 may include, at 1006, determining second delay information associated with second data in the buffer. For example, the delay information may be based on the data's CDF and statistical attributes.

The operation flow/algorithmic structure 1000 may include, at 1008, determining a differential value based on the first and second delay information. The UE may select the first delay information as the reference report. The UE may select the first delay information based on the statistical attributes, CDF, or delay properties of the data associated with the delay information or based on the QoS, urgency, or priority of the LCHs or LCGs associated with the data. The differential value may be calculated based on a function that includes the first and second delay information. For example, the differential value may be the difference between the first and second delay information or a weighted sum of the two delay information. The UE may use tables to compress or encode the reference and differential reports as described above.

The operation flow/algorithmic structure 1000 may include, at 1010, generating a control message including a reference report and a dependent report (or a differential report), a reference report based on the first buffer delay information, and a dependent report based on the differential value. For example, the UE may generate a MAC CE, in accordance with the embodiments herein, and include the delay information and an indication of the delay information in the MAC CE.

The operation flow/algorithmic structure 1000 may include, at 1012, transmitting the control message. The UE may send the MAC CE to the UE in an uplink transmission on the physical uplink control channel (PUCCH) or physical uplink shared channel (PUSCH).

FIG. 11 illustrates an operational flow/algorithmic structure 1100 in accordance with some embodiments. Operational flow/algorithmic structure 1100 is an example of operating BS to provide delay-aware scheduling based on differential delay reporting by the UE. The operational flow/algorithmic structure 1100 may be implemented by a network node, for example, the AN 108, the network node 1300, or components therein, e.g., processors 1304.

The operational flow/algorithmic structure 1100 may include, at 1104, receiving a control message from a UE. The control message may be an uplink control message. For example, the first message may be a MAC CE carrying buffer delay information. The MAC CE may include a reference report and a differential report.

The operational flow/algorithmic structure 1100 may include, at 1106, determining first delay information. The BS may determine the first delay information based on the reference report of the received control message.

The operational flow/algorithmic structure 1100 may include, at 1108, determining second delay information. The BS may determine the second delay information based on the reference report, the first delay information, or the differential report. For example, the BS may determine a differential value based on the differential report and compute the second delay information by adding the differential value to the first delay information.

The operational flow/algorithmic structure 1100 may include, at 1110, generating a downlink (DL) control message. The BS may perform uplink delay-aware scheduling based on the first and second delay information. Based on the delay-aware scheduling, the BS may generate a UL grant allocating resources for UL transmission to the UE. The control message may be a DCI.

The operational flow/algorithmic structure 1100 may include, at 1112, transmitting the DL control message. The BS may send the DL control message on the physical downlink control channel (PDCCH) or physical downlink shared channel (PDSCH).

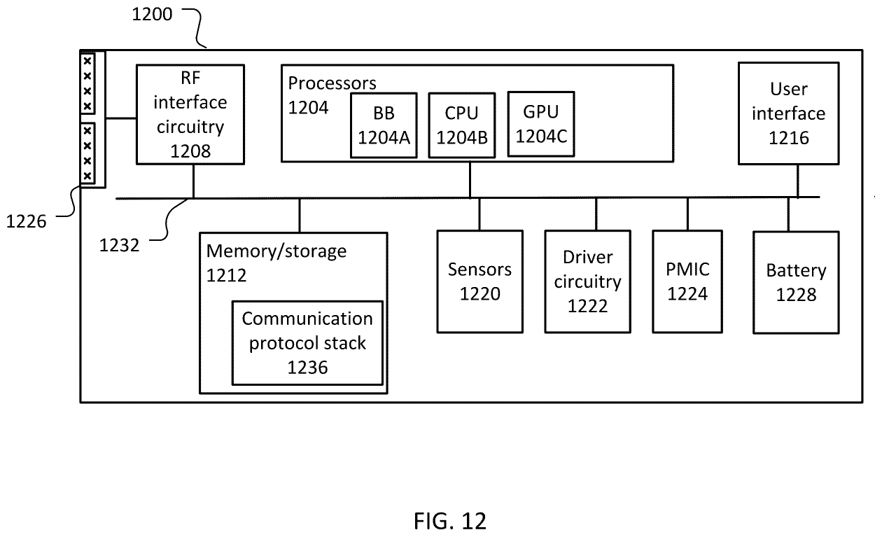

FIG. 12 illustrates a UE 1200 in accordance with some embodiments. The UE 1200 may be similar to and substantially interchangeable with UE 104 of FIG. 1.

The UE 1200 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smartwatch), or Internet-of-things device.

The UE 1200 may include processors 1204, RF interface circuitry 1208, memory/storage 1212, user interface 1216, sensors 1220, driver circuitry 1222, power management integrated circuit (PMIC) 1224, antenna structure 1226, and battery 1228. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangements of the components shown may occur in other implementations.

The components of the UE 1200 may be coupled with various other components over one or more interconnects 1232, which may represent any type of interface, input/output, bus (local, system, or expansion), transmission line, trace, or optical connection that allows various circuit components (on common or different chips or chipsets) to interact with one another.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry, or processor circuitry that executes or otherwise operates computer-executable instructions, such as program code, software modules, or functional processes from memory/storage 1212 to cause the UE 1200 to perform operations as described herein.

The processors 1204 may perform operations associated with bearer flows as described elsewhere herein. For example, processors 1204 generate control messages to report buffer delay information consistent with the embodiments described herein.

In some embodiments, the baseband processor circuitry 1204A may access a communication protocol stack 1236 in the memory/storage 1212 to communicate over a 3GPP-compatible network. In general, the baseband processor circuitry 1204A may access the communication protocol stack 1236 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1208.

The baseband processor circuitry 1204A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 1212 may include one or more non-transitory, computer-readable media that include instructions (for example, the communication protocol stack 1236) that may be executed by one or more of the processors 1204 to cause the UE 1200 to perform various operations described herein. The memory/storage 1212 includes any type of volatile or non-volatile memory that may be distributed throughout the UE 1200. In some embodiments, some of the memory/storage 1212 may be located on the processors 1204 themselves (for example, L1 and L2 cache), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 1208 may include transceiver circuitry and a radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1226 and proceed to filter and amplify (with a low-noise amplifier) the signal. The signal may be provided to a receiver of the transceiver that down-converts the RF signal into a baseband signal that is provided to the baseband processor of the processor 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1226.

In various embodiments, the RF interface circuitry 1208 may be configured to transmit/receive signals in a manner compatible with NR access technologies.

The antenna 1226 may include antenna elements to convert electrical signals into radio waves to travel through the air and to convert received radio waves into electrical signals. The antenna elements may be arranged into one or more antenna panels. The antenna 1226 may have antenna panels that are omnidirectional, directional, or a combination thereof to enable beamforming and multiple input, multiple output communications. The antenna 1226 may include microstrip antennas, printed antennas fabricated on the surface of one or more printed circuit boards, patch antennas, or phased array antennas. The antenna 1226 may have one or more panels designed for specific frequency bands, including bands in FR1 or FR2.

The user interface circuitry 1216 includes various input/output (I/O) devices designed to enable user interaction with the UE 1200. The user interface 1216 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1200.

The sensors 1220 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various I/O devices that may be present within or connected to the UE 1200. For example, the driver circuitry 1222 may include circuitry to facilitate the coupling of a universal integrated circuit card (UICC) or a universal subscriber identity module (USIM) to the UE 1200. For additional examples, driver circuitry 1222 may include a display driver to control and allow access to a display device, a touchscreen driver to control and allow access to a touchscreen interface, sensor drivers to obtain sensor readings of sensor circuitry 1220 and control and allow access to sensor circuitry 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage the power provided to various components of the UE 1200. In particular, with respect to the processors 1204, the PMIC 1224 may control power-source selection, voltage scaling, battery charging, or DC-to-DC conversion.

In some embodiments, the PMIC 1224 may control or otherwise be part of various power-saving mechanisms of the UE 1200, including DRX, as discussed herein.

A battery 1228 may power the UE 1200, although in some examples, the UE 1200 may be mounted and deployed in a fixed location and may have a power supply coupled to an electrical grid. The battery 1228 may be a lithium-ion battery, a metal-air battery, such as a zinc-air battery, an aluminum-air battery, a lithium-air battery, and the like. In some implementations, such as in vehicle-based applications, the battery 1228 may be a typical lead-acid automotive battery.

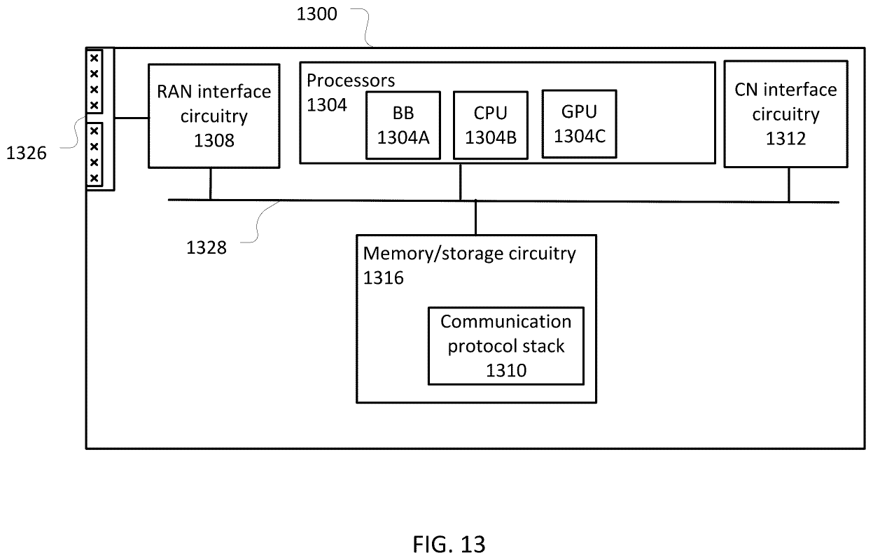

FIG. 13 illustrates a network node 1300 in accordance with some embodiments. The network node 1300 may be similar to and substantially interchangeable with base station 108, a device implementing one of the network hops, an integrated access and backhaul (IAB) node, a network-controlled repeater, or a server in a core network or external data network.

The network node 1300 may include processors 1304, RF interface circuitry 1308 (if implemented as an access node), the core node (CN) interface circuitry 1312, memory/storage circuitry 1316, and antenna structure 1326.

The components of the network node 1300 may be coupled with various other components over one or more interconnects 1328.

The processors 1304, RF interface circuitry 1308, memory/storage circuitry 1316 (including communication protocol stack 1310), antenna structure 1326, and interconnects 1328 may be similar to like-named elements shown and described with respect to FIG. 12.

The processors 1304 may perform operations associated with bearer flows as described elsewhere herein. For example, the processors 1304 may generate control message to report buffer delay information consistent with embodiments described herein.

The CN interface circuitry 1312 may provide connectivity to a core network, for example, a 5th Generation Core network (5GC) using a 5GC-compatible network interface protocol such as carrier Ethernet protocols or some other suitable protocol. Network connectivity may be provided to/from the network node 1300 via a fiber optic or wireless backhaul. The CN interface circuitry 1312 may include one or more dedicated processors or FPGAs to communicate using one or more of the aforementioned protocols. In some implementations, the CN interface circuitry 1312 may include multiple controllers to provide connectivity to other networks using the same or different protocols.

In some embodiments, the network node 1300 may be coupled with transmit-receive points (TRPs) using the antenna structure 1326, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### EXAMPLES

In the following sections, further exemplary aspects are provided.

Example 1 includes a method of operating a user equipment (UE), the method including: determining a distribution of data in a buffer; determining, based on the distribution, delay information that corresponds to a percentile value; generating a control message based on the delay value; and transmitting the control message.

Example 2 includes the method of example 1 or other examples herein, wherein the control message is a medium access control (MAC) control element (CE).

Example 3 includes the method of examples 1 or 2 or other examples herein, further including: receiving, from a base station, a configuration that includes an indication of the percentile value.

Example 4 includes the method of any of examples 1-3 or other examples herein, wherein the distribution is based on a waiting time of the data in the buffer, a remaining time until a delivery deadline of the data in the buffer, or an estimated time until completing transmission of the data in the buffer.

Example 5 includes the method of any of examples 1-4 or other examples herein, wherein the data comprises a packet data convergence protocol (PDCP) service data unit (SDU), a PDCP PDU, a radio link control (RLC) SDU, an RLC PDU, an RLC SDU segment, a PDU set, or data associated with a quality of service (QOS) flow.

Example 6 includes the method of any of examples 1-5 or other examples herein, wherein the buffer is associated with a logical channel (LCH) or a logical channel group (LCG).

Example 7 includes the method of any of examples 1-6 or other examples herein, wherein the data in the buffer belong to one or more protocol data unit (PDU) sets.

Example 8 includes the method of any of examples 1-7 or other examples herein, wherein a first data unit of the data arrives at the buffer at a first arrival time and a second data unit of the data arrives at the buffer at a second arrival time, and the first arrival time differs from the second arrival time.

Example 9 includes the method of any of examples 1-8 or other examples herein, wherein the delay information is a statistical value associated with the data in the buffer, the statistical value including a maximum value, a minimum value, an average value, a median value, a standard deviation value, or a variance value.

Example 10 includes a method of operating a user equipment (UE), the method including: determining first buffer delay information associated with first data in a buffer; determining second buffer delay information associated with second data in the buffer; determining a differential value based on the first buffer delay information and the second buffer delay information; generating a control message to indicate the first buffer delay information and the differential value; and transmitting the control message.

Example 11 includes the method of examples 10 or other examples herein, wherein the first delay information is associated with a remaining time until a delivery deadline for the first data in the first buffer or a queuing time in the first buffer.

Example 12 includes the method of examples 10 or 11 or other examples herein, wherein the control message includes a reference report, the reference report is to indicate the first buffer delay.

Example 13 includes the method of any of examples 10-12 or other examples herein, further including: receiving a configuration including a table; determining the reference report based on the first buffer delay information and the table.

Example 14 includes the method of any of examples 10-13 or other examples herein, further including: receiving a configuration including a table; determining the differential value based on the first buffer delay information and the table.

Example 15 includes the method of any of examples 10-14 or other examples herein, wherein the control message is a medium access control (MAC) control element (CE).

Example 16 includes the method of any of examples 10-15 or other examples herein, wherein the first buffer is associated with a first logical channel (LCH) or a first logical channel group (LCG) and the second buffer is associated with a second LCH or a second LCG.

Example 17 includes the method of any of examples 10-16 or other examples herein, further comprising: determining a distribution based on the first data in the first buffer or the second data in the second buffer.

Example 18 includes the method of any of examples 10-17 or other examples herein, wherein the first delay information is based on a first percentile associated with the distribution or the second delay information is based on a second percentile associated with the distribution.

Example 19 includes a method of operating a base station (BS), the method including: receiving, from a user equipment (UE), an uplink control message including a reference report and a differential report; determining, based on the reference report, first delay information associated with first data in a buffer; determining, based on the reference report or the differential report, second delay information associated with the first data or second data in the buffer; generating a downlink control message based on the first delay information or the second delay information; and transmitting the downlink control message.

Example 20 includes the method of example 19 or other examples herein, wherein the control message is a medium access control (MAC) control element (CE).

Another example may include an apparatus comprising logic, modules, or circuitry to perform one or more elements of a method described in or related to any of examples 1-20, or any other method or process described herein.

Another example may include a method, technique, or process as described in or related to any of examples 1-20 or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example includes a signal as described in or related to any of examples 1-20 or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed. Modifications and variations are possible in light of the above teachings or may be acquired from the practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
determining a distribution of data in a buffer;
determining, based on the distribution, delay information that corresponds to a percentile value; and
generating a control message based on the delay value.

2. The method of claim 1, further comprising:
processing a configuration received from a base station that includes an indication of the percentile value.

3. The method of claim 1, wherein the distribution is based on a waiting time of the data in the buffer, a remaining time until a delivery deadline of the data in the buffer, or an estimated time until completing transmission of the data in the buffer.

4. The method of claim 1, wherein the data comprises a packet data convergence protocol (PDCP) service data unit (SDU), a PDCP PDU, a radio link control (RLC) SDU, an RLC PDU, an RLC SDU segment, a PDU set, or data associated with a quality of service (QOS) flow.

5. The method of claim 1, wherein the buffer is associated with a logical channel (LCH) or a logical channel group (LCG).

6. The method of claim 5, wherein the data in the buffer belong to one or more protocol data unit (PDU) sets.

7. The method of claim 5, wherein a first data unit of the data arrives at the buffer at a first arrival time and a second data unit of the data arrives at the buffer at a second arrival time, and the first arrival time differs from the second arrival time.

8. The method of claim 1, wherein the delay information is a statistical value associated with the data in the buffer, the statistical value including a maximum value, a minimum value, an average value, a median value, a standard deviation value, or a variance value.

9. A baseband processor comprising:
processing circuitry configured to:
determine first buffer delay information associated with first data in a buffer;
determine second buffer delay information associated with second data in the buffer;
determine a differential value based on the first buffer delay information and the second buffer delay information; and
generate a control message including the first buffer delay information and the differential value; and
interface circuitry to communicatively couple the processing circuitry to a component of a device.

10. The baseband processor of claim 9, wherein the first delay information is associated with a remaining time until a delivery deadline for the first data in the first buffer or a queuing time in the first buffer.

11. The baseband processor of claim 9, wherein the control message includes a reference report, the reference report is to indicate the first buffer delay.

12. The baseband processor of claim 11, wherein the processing circuitry is configured further to:
process a configuration including a table; and
determine the reference report based on the first buffer delay information and the table.

13. The baseband processor of claim 9, wherein the processing circuitry is configured further to:
process a configuration including a table; and
determine the differential value based on the first buffer delay information and the table.

14. The baseband processor of claim 9, wherein the control message is a medium access control (MAC) control element (CE).

15. The baseband processor of claim 9, wherein the first buffer delay information is associated with a first logical channel (LCH) or a first logical channel group (LCG) and the second buffer delay information is associated with a second LCH or a second LCG.

16. The baseband processor of claim 9, wherein the first data and the second data are associated with a logical channel LCH or a logical channel group (LCG).

17. The baseband processor of claim 9, wherein the processing circuitry is configured further to:
determine a distribution based on the first data in the first buffer or the second data in the second buffer.

18. The baseband processor of claim 17, wherein the first delay information is based on a first percentile associated with the distribution or the second delay information is based on a second percentile associated with the distribution.

19. One or more non-transitory computer-readable media having instructions that are to be executed to cause processing circuitry to:
process an uplink control message received from a user equipment (UE), the uplink control message including a reference report and a differential report;
determine, based on the reference report, first delay information associated with first data in a buffer;
determine, based on the reference report or the differential report, second delay information associated with the first data or second data in the buffer; and
generate a downlink control message based on the first delay information or the second delay information.

20. The one or more non-transitory computer-readable media of claim 19, wherein the control message is a medium access control (MAC) control clement (CE).
